(19) United States
(12) Patent Application Publication
(10) Pub. No.: US 2017/0091896 A1
(43) Pub. Date: Mar. 30, 2017

(54) INDEPENDENT MULTI-SOURCE DISPLAY DEVICE

(71) Applicant: SAMSUNG DISPLAY CO., LTD., Yongin-City (KR)

(72) Inventors: Ning Lu, Saratoga, CA (US); Janghwan Lee, Pleasanton, CA (US); Yiwei Zhang, Milipitas, CA (US)

(21) Appl. No.: 15/145,761

(22) Filed: May 3, 2016

Related U.S. Application Data
(60) Provisional application No. 62/234,855, filed on Sep. 30, 2015.

(51) Int. Cl. G06T 1/20

(52) U.S. Cl. CPC G06T 1/20

(57) ABSTRACT

An independent multi-source display device including: a multi-input receiver configured to concurrently receive a plurality of input data from input sources external to the independent multi-source display device, each of the input data having a display element structure indicating a data format, a depth order, a size, a position, and a content, the multi-input receiver including: formatters, each being configured to convert an input data having a data format associated with the formatter to uncompressed data; and a data classifier configured to identify a data format associated with each of the input data based on a respective display element structure of each of the input data; a compositor coupled to the formatters and configured to composite the uncompressed data into composite frames based on the display element structure associated with each of the received uncompressed data; and a display panel configured to display the composite frames.

### CROSS-REFERENCE TO RELATED APPLICATION(S)

This application claims priority to, and the benefit of, U.S. Provisional Application No. 62/234,855 (“Independent Multi-source Display Device”), filed on Sep. 30, 2015, the entire content of which is incorporated herein by reference.

### FIELD

Aspects of the present invention relate to the field of display panels.

### BACKGROUND

Today, a display device generally functions as a peripheral component of a computational device, such as a personal computer. When displaying content from multiple sources at the same time, an application software (e.g., a web browser or operating system) of the computational device together with installed dedicated software (e.g., video codecs or plugins) associated with each of the multiple sources converge the content from the multiple sources into frame buffers, which are then delivered to the display device.

In such architecture, the application system becomes the bottleneck. Because of the variation of application systems and uncertainty of other running application software, the display experience is often compromised.

The above information disclosed in this Background section is only for enhancement of understanding of the background of the invention and therefore it may contain information that does not form the prior art that is already known to a person of ordinary skill in the art.

### SUMMARY

Aspects of embodiments of the present invention are directed to an independent multi-source display device capable of concurrently receiving a plurality of input data, each of which has a particular display element structure, from a plurality of input sources that are external to the multi-source display device and compositing the input data as composite frames to be displayed on a display panel. According to some embodiments, the independent multi-source display device concurrently and separately communicates with each of the plurality of input sources without the use of an intervening central operating system or device external to the independent multi-source display device.

Aspects of embodiments of the present invention are directed to methods of receiving and compositing content on the independent multi-source display device.

According to some embodiments of the present invention, there is provided an independent multi-source display device including: a multi-input receiver configured to concurrently receive a plurality of input data from a plurality of input sources external to the independent multi-source display device, each of the plurality of input data having a display element structure indicating a data format, a depth order, a size, a position, and a content, the multi-input receiver including: a plurality of formatters, each formatter of the plurality of formatters being configured to convert an input data having a data format associated with the formatter to uncompressed data; and a data classifier configured to identify a data format associated with each of the plurality of input data based on a respective display element structure of each of the plurality of input data, and to transmit each of the plurality of input data to one of the plurality of formatters associated with the identified data format; a compositor coupled to the plurality of formatters and configured to composite uncompressed data received from the plurality of formatters into composite frames based on the display element structure associated with each of the received uncompressed data; and a display panel configured to display the composite frames.

In an embodiment, the multi-input receiver is configured to concurrently and separately communicate with each of the plurality of input sources without intervention of a central operating system or device external to the independent multi-source display device.

In an embodiment, the plurality of input sources includes a mobile electronic device in wireless communication with the independent multi-source display device.

In an embodiment, the compositor is not integrated with, and packaged separately from, the plurality of formatters.

In an embodiment, the multi-input receiver is configured to buffer the received plurality of input data in a ping-pong buffer.

In an embodiment, the uncompressed data has an RGBA format including, red, green, and blue color information and alpha channel information.

In an embodiment, the compositor is configured to composite the composite frames by blending overlapping uncompressed data using the alpha channel information associated with each of the overlapping uncompressed data.

In an embodiment, the compositor is configured to composite the composite frames based on the depth order, the size, and the position of each of the uncompressed data received from the plurality of formatters, as determined based on the display element structure associated with each of the received uncompressed data.

According to some embodiments of the present invention, there is provided an independent multi-source display device including: a multi-input receiver configured to concurrently receive a plurality of input data from a plurality of input sources external to the independent multi-source display device, each of the plurality of input data having a display element structure indicating a data format, a depth order, a size, a position, and a content; a compositor coupled to the receiver and including: a plurality of formatters, each formatter of the plurality of formatters being configured to convert an input data having a data format associated with the formatter to uncompressed data, the compositor being configured to identify a data format associated with each of the plurality of input data based on a respective display element structure of each of the plurality of input data, and to transmit each of the plurality of input data to one of the plurality of formatters associated with the identified data format, the compositor being further configured to composite uncompressed data generated by the plurality of formatters into composite frames based on the display element structure associated with each of the received uncompressed data; and a display panel configured to display the composite frames.

In an embodiment, the multi-input receiver is configured to concurrently and separately communicate with each of the plurality of input sources without intervention of a central operating system or device external to the independent multi-source display device.

In an embodiment, the plurality of input sources includes a mobile electronic device in wireless communication with the independent multi-source display device.

In an embodiment, the compositor is not integrated with, and packaged separately from, the plurality of formatters.

In an embodiment, the multi-input receiver is configured to buffer the received plurality of input data in a ping-pong buffer.

In an embodiment, the uncompressed data has an RGBA format including, red, green, and blue color information and alpha channel information.

In an embodiment, the compositor is configured to composite the composite frames by blending overlapping uncompressed data using the alpha channel information associated with each of the overlapping uncompressed data.

In an embodiment, the compositor is configured to composite the composite frames based on the depth order, the size, and the quadrilateral position of each of the uncompressed data received from the plurality of formatters, as determined based on the display element structure associated with each of the received uncompressed data.

According to some embodiments of the present invention, there is provided a method for displaying content on an independent multi-source display device, the method including: receiving, by a multi-input receiver, a plurality of input data from a plurality of input sources external to the independent multi-source display device, each of the plurality of input data having a display element structure indicating a data format, a depth order, a size, a position, and a content; identifying a data format associated with each of the plurality of input data based on a respective display element structure of each of the plurality of input data; transmitting each of the plurality of input data to one of a plurality of formatters associated with the identified data format; converting, by the plurality of formatters, the plurality of input data to uncompressed data; compositing, by a compositor, uncompressed data generated by the plurality of formatters into composite frames based on the display element structure associated with each of the received uncompressed data; and displaying the composite frames on a display panel.

In an embodiment, the multi-input receiver is configured to concurrently and separately communicate with each of the plurality of input sources without intervention of a central operating system or device external to the independent multi-source display device.

In an embodiment, the uncompressed data has an RGBA format including, red, green, and blue color information and alpha channel information.

In an embodiment, the compositor is configured to composite the composite frames based on the depth order, the size, and the quadrilateral position of each of the uncompressed data received from the plurality of formatters, as determined based on the display element structure associated with each of the received uncompressed data.

### BRIEF DESCRIPTION OF THE DRAWINGS

The accompanying drawings, together with the specification, illustrate example embodiments of the present invention, and, together with the description, serve to explain the principles of the present invention.

FIG. 1 is a block diagram illustrating an independent multi-source display device according to some exemplary embodiments of the present invention.

FIG. 2 is a block diagram illustrating an independent multi-source display device according to some other exemplary embodiments of the present invention.

FIG. 3 is a method of receiving and compositing content on the independent multi-source display device according to some exemplary embodiments of the present invention.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. Descriptions of features or aspects within each exemplary embodiment should typically be considered as available for other similar features or aspects in other exemplary embodiments. Like reference numerals designate like elements throughout the specification.

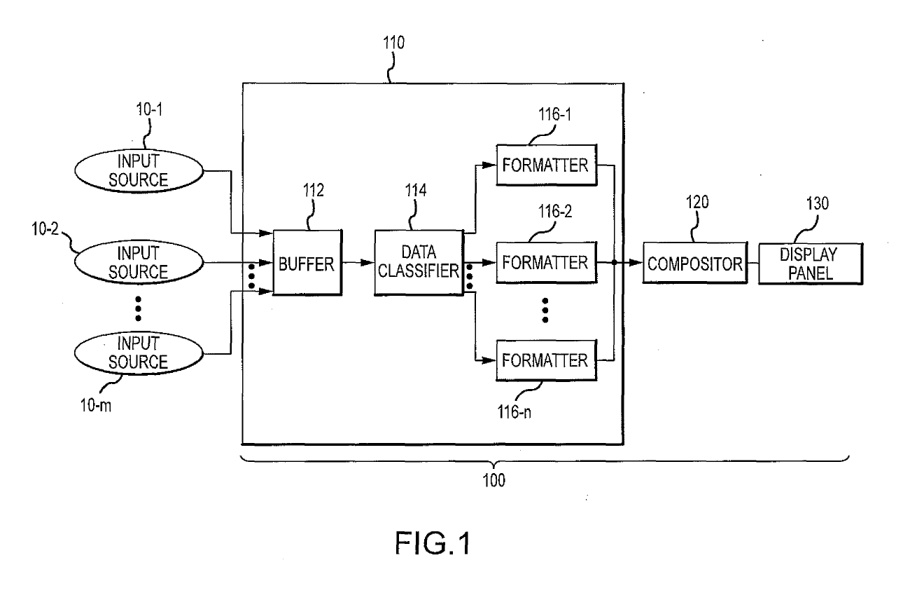

FIG. 1 is a block diagram illustrating an independent multi-source display device 100 according to some embodiments of the present invention.

Referring to FIG. 1, the independent multi-source display device 100 includes a multi-input receiver 110 for receiving input data from a plurality of input sources 10-1 to 10-m (where m is an integer greater than 1), a compositor 120 for compositing the data streams from the multi-input receiver 110 and for generating (e.g., rendering) composite frames, and a display panel 130 for displaying the composite frames. The multi-input receiver 110 allows the display device 100 to directly receive various forms of input data from the plurality of sources 10-1 to 10-n, to convert the input data into uncompressed data, and to compose the data into frames that are then displayed.

According to some embodiments, the multi-input receiver 110 concurrently and separately communicates (e.g., directly communicates) with each of the plurality of input sources 10-1 to 10-m without the use of an intervening central operating system or device external to the independent multi-source display device 100. In some examples, the communication may be through a wired connection, such as an electrical cable, fiber optic, and/or the like, or may be through a wireless connection, such as Bluetooth, Wi-Fi, line-of-sight optics, and or the like.

In some embodiments, the input data from each of the input sources 10-1 to 10-m may have a display element structure, which includes, for example, data format (e.g., video format), depth order, size, quadrilateral position, and content. In some examples, the input data from the input sources 10-1 to 10-m may overlap in position (e.g., as viewed on the display panel 130). According to some examples, the display element structure may be expressed in pseudo-code as follows:

Typedef struct DisplayElement
{

// format index, 0 = not compressed
int Format;
// Z-order, 0 = background
int Zorder;
// dimension: width and height
int w,h;
// pixel data point
uchar *pData;
// destination quadrilateral
int *pDest[4][2];

} DISEL;

where the format index Format indicates how the input data is formatted. When Format is set to 0 it indicates that the data is not compressed (e.g., as raw RGBA data). When the format is set to a non-zero number, the number indicates the type of compression being used (e.g. a ‘1’ may indicate JPEG data, a ‘2’ may indicate MPEG data, etc.). The data format may include any suitable image and/or video format, such as RGBA, RGBA, JPEG, TIFF, PNG, YUV422, YUV420, and/or the like, or a text or line-drawing format. Further, in the above pseudo-code the depth order (or z-order) Zorder indicates the order in which overlapping content from the various input data may be displayed on the display panel 130 (e.g., input data having higher Zorder may be displayed in front of input data having a lower Zorder); the width and height w and h, respectively, indicate the display size of the content of the input data; the content indicator pData points to the content of the input data; and the destination indicator pDest indicates the quadrilateral region on the display panel on which to render the input data.

According to some embodiments, the multi-input receiver 110 includes a buffer 112, a data classifier 114, and a plurality of formatters 116-1 to 116-n (where n is an integer greater than 1). The buffer 112 may temporarily store incoming input data from the input sources 10-1 to 10-m, which may be received in discrete packets. The receiver 110 may handle data synchronization with the input sources 10-1 to 10-m, and in examples in which the buffer 112 is a ping-pong memory buffer, the receiver 110 may manage the concurrent read and write operation to and from the buffer 112.

In some embodiments, the input data arrives at the receiver 110 having the display element structure. However, in some examples, the information associated with the display element structure of a given input data may not all arrive from the same input source or even at the same time. For instance, image data (e.g., Format, w, h, pData) and image placement (e.g., Zorder and pDest) may be received from different sources (e.g., from different ones of the input sources 10-1 to 10-m) and/or at different times. In such instances, the receiver 110, according to some embodiments, may queue the received information in the buffer 112 as it arrives and construct the display element structure for a given input data once it has collected all of the relevant information.

Once input data having the display element structure is received or formulated by the receiver 110, the data classifier 114 classifies the input data from the multiple input sources 10-1 to 10-m using the respective display element structures (e.g. using the format index Format), and forwards each input data to an appropriate one of the formatters 116-1 to 116-n.

According to some embodiments, each of the formatters 116-1 to 116-n is a transcoder that converts a particular type of input data into an internal uncompressed format type to improve display performance of the independent multi-source display device 100. For example, the first formatter 116-1 may transcode images (e.g., JPEG, GIF, . . . images), the second formatter 116-2 may transcode videos (e.g., AVC, HEVC, MPEG, . . . videos), the third formatter 116-3 may transcode graphics data (e.g., line, shade, and/or the like), and a fourth formatter 116-4 may transcode text data (e.g., texts having predefined fonts). However, the present invention is not limited thereto, and the formatters 116-1 to 116-n may transcode any suitable type of input data into the internal format type.

In some embodiments, the internal format type may be RGBA, which contains red, green, and blue color information and alpha channel information (e.g., indicating opacity of the corresponding image to be displayed). The alpha channel information may be embedded within the input data pointed to by the content indicator pData (e.g., when the input format is RGBA). However, embodiments of the present invention are not limited thereto, and the internal format type may be any suitable type as recognized by a person of ordinary skill in the art. For example, the internal format type may be RGB.

According to some embodiments, the formatters 116-1 to 116-n also provide predefined graphics capabilities, such as, text-to-image rendering according to given or preloaded fonts, line and curve drawing, shade casting of some objects, and/or the like.

For example, one or more of the formatters 116-1 to 116-n may be pre-programmed with one or more fonts and may be capable of rendering input text having the one of the pre-programmed fonts (e.g., as indicated by the format indicator Format). In some examples, the format indicator Format of an input data may indicate a static image such as a line, a curve, a rectangle, and/or the like, and one or more of the formatters 116-1 to 116-n may be capable of rendering such input data.

According to some embodiments, the compositor 120 receives the transcoded input data that is of the internal format type (e.g., uncompressed RGBA) and the associated display element structure from each of the formatters 116-1 to 116-n and composes a sequence of rectangular image pieces (e.g., rectangular RGBA image pieces) that are sorted according to their depth orders (Zorders), and renders the resulting composition, as a composite frame, to a quadrilateral region on the display panel 130. The composite frame sent to the display panel 130 may have the internal format type (e.g., RGBA). The compositor 120 may perform the above process for every frame displayed on the display panel 130 at the display panel refresh rate.

In some examples, when some of the rectangular image pieces overlap in the visible quadrilateral space of the display panel 130, the compositor may render the composite frames by blending overlapping uncompressed data using the alpha channel information associated with each of the overlapping uncompressed data.

According to some examples, the function performed by the compositor 120 may be expressed in pseudo-code as follows:

void Compositor( int num, DISEL *de )
{

// loop through Z-order
for( int z=0; z<MAX_ZORDER; z++ ){
// loop through all display elements
for( int i=0; i<num; i++ ){
if( de[i].Zorder==z ){
// rendering to screen: pFrame
Render( de[i].w, de[i].h, de[i].pDest, pRGBA, pFrame );
}}}

}

Thus, according to some embodiments, the compositor iterates and renders the various inputs according to Z-order. For example, as shown in the pseudo code above, the compositor starts by rendering the background (Zorder=0), followed by the remaining inputs in order according to order of the input on the screen (e.g., Zorder=1, 2, . . . ).

In the embodiments of FIG. 1, the formatters 116-1 to 116-n are not integrated with the compositor 120 and, for example, may form separate hardware modules (e.g., separate IC chips) that are packaged separately. By not including the transcoding function within the compositor 120, such architecture allows the compositor 120 to have a simplified compact design.

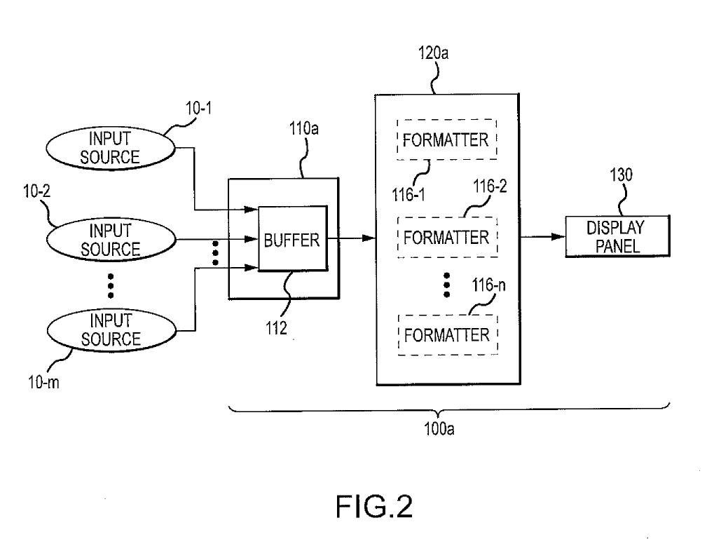

FIG. 2 is a block diagram illustrating an independent multi-source display device 100a according to some other embodiments of the present invention.

Referring to FIG. 2, according to some embodiments, the function of the data classifier 114 and the transcoding function of the formatters 116-1 to 116-n of FIG. 1 are moved from the receiver 110a to the compositor 120a. Otherwise, the receiver 110a may buffer incoming data and perform memory management in the same or substantially the same manner as the receiver 110 of FIG. 1. The compositor 120a may perform substantially the same function as the compositor 120 of FIG. 1 with the added functionality of the data classifier 114 and the formatters 116-1 to 116-n.

According to some examples, the function performed by the compositor 120a may be expressed in pseudo-code as follows:

void Compositor( int num, DISEL *de )
{

// loop through Z-order
for( int z=0; z<MAX_ZORDER; z++ ){
// loop through all display elements
for( int i=0; i<num; i++ ){
if( de[i].Zorder==z ){
// decoding to RGBA, in pRGBA
Decode( de[i].Format, de[i].w, de[i].h, de[i].pData, pRGBA );
// rendering to screen; pFrame
Render( de[i].w, de[i].h, de[i].pDest, pRGBA, pFrame );
}}}

}

The integrated decoding functionality of the compositor 120a, while adding to its design complexity, allows the compositor 120a to receive compressed (or coded) input data from the receiver 110a, which may consume less transmission bandwidth than the uncompressed data sent to the compositor 120 in the embodiments of FIG. 1. Thus, the embodiments of FIG. 2 may be more suitable than those of FIG. 1 for use in applications where data bandwidth of the transmission interface between the receiver and the compositor 120a is limited.

According to the above, the independent multi-source display device 100/100a (e.g., the multi-Input receiver 110/110a) concurrently and separately communicates (e.g., directly communicates) with each of the plurality of input sources without the use of an intervening central operating system or device external to the independent multi-source display device 100/100a.

According to some examples, the independent multi-source display device 100/100a may be connected to the input sources 10-1 to 10-m through a wired connection or may be connected wirelessly. For example, an input source may be a low-power mobile device, such as a smartphone or a smartwatch.

In some examples, the independent multi-source display device 100/100a may serve as a digital wall, which allows multiple users to use parts of the display panel independently in a shared manner, without having to coordinate the shared experience through an intervening centralized application or separate dedicated device.

In some examples, the independent multi-source display device 100/100a may also be used in a cloud-based architecture for augmented reality, in which the display data may arrive from different sources over the internet and be composed real-time by the independent multi-source display device 100/100a at the client end. In an example in which the independent multi-source display device 100/100a is implemented within a head-mounted display device, the multi-source display device 100/100a may receive a plurality of input data from a plurality of remote servers, which represent various augmented reality features, and composite them in real-time, allowing the user of the device to concurrently experience the multiple augmented features provided from multiple remote servers.

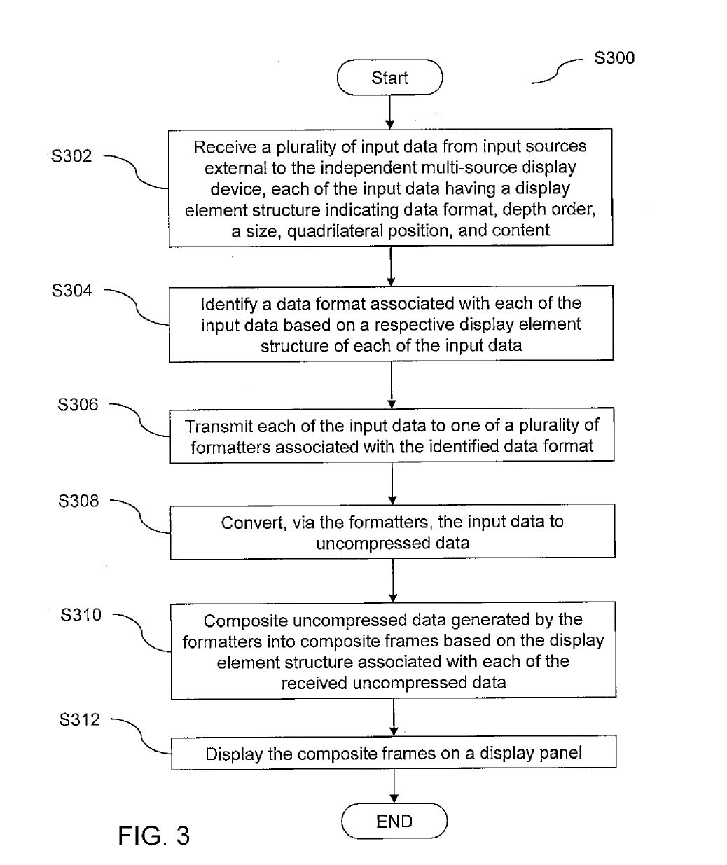

FIG. 3 is a method of receiving and compositing content on the independent multi-source display device 100/100a according to some embodiments of the present invention.

In act S302, a multi-input receiver 110/110a receives a plurality of input data from a plurality of input sources 10-1 to 10-m external to the independent multi-source display device 100/100a. Each of the plurality of input data may have a display element structure indicating data format, depth order, size, quadrilateral position, and content.

In act S304, the receiver 110 or the compositor 120a identifies a data format associated with each of the plurality of input data based on a respective display element structure of each of the plurality of input data.

In act S306, each of the plurality of input data is transmitted to one of a plurality of formatters associated with the identified data format.

In act S308, the plurality of formatters 116-1 to 116-n convert the plurality of input data to uncompressed data.

In act S310, the compositor 120/120a composites (e.g., renders) uncompressed data generated by the plurality of formatters 116-1 to 116-n into composite frames based on the display element structure associated with each of the received uncompressed data.

In act S312, the display panel 130 displays the composite frames.

It will be understood that, although the terms “first”, “second”, “third”, etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section discussed below could be termed a second element, component, region, layer or section, without departing from the spirit and scope of the inventive concept.

The terminology used herein is for the purpose of describing particular embodiments and is not intended to be limiting of the inventive concept. As used herein, the singular forms “a” and “an” are intended to include the plural forms as well, unless the context clearly indicates otherwise. It will be further understood that the terms “include,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the inventive concept.” Also, the term “exemplary” is intended to refer to an example or illustration.

It will be understood that when an element or layer is referred to as being “on”, “connected to”, “coupled to”, or “adjacent” another element or layer, it can be directly on, connected to, coupled to, or adjacent the other element or layer, or one or more intervening elements or layers may be present. When an element or layer is referred to as being “directly on,” “directly connected to”, “directly coupled to”, or “immediately adjacent” another element or layer, there are no intervening elements or layers present.

As used herein, the term “substantially,” “about,” and similar terms are used as terms of approximation and not as terms of degree, and are intended to account for the inherent variations in measured or calculated values that would be recognized by those of ordinary skill in the art.

As used herein, the terms “use,” “using,” and “used” may be considered synonymous with the terms “utilize,” “utilizing,” and “utilized,” respectively.

The independent multi-source display device and/or any other relevant devices or components according to embodiments of the present invention described herein may be implemented utilizing any suitable hardware, firmware (e.g. an application-specific integrated circuit), software, or a suitable combination of software, firmware, and hardware. For example, the various components of the independent multi-source display device may be formed on one integrated circuit (IC) chip or on separate IC chips. Further, the various components of the independent multi-source display device may be implemented on a flexible printed circuit film, a tape carrier package (TCP), a printed circuit board (PCB), or formed on the same substrate. Further, the various components of the independent multi-source display device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer-readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the exemplary embodiments of the present invention.

What is claimed is:

1. An independent multi-source display device comprising:
a multi-input receiver configured to concurrently receive a plurality of input data from a plurality of input sources external to the independent multi-source display device, each of the plurality of input data having a display element structure indicating a data format, a depth order, a size, a position, and a content, the multi-input receiver comprising:
a plurality of formatters, each formatter of the plurality of formatters being configured to convert an input data having a data format associated with the formatter to uncompressed data; and
a data classifier configured to identify a data format associated with each of the plurality of input data based on a respective display element structure of each of the plurality of input data, and to transmit each of the plurality of input data to one of the plurality of formatters associated with the identified data format;
a compositor coupled to the plurality of formatters and configured to composite uncompressed data received from the plurality of formatters into composite frames based on the display element structure associated with each of the received uncompressed data; and
a display panel configured to display the composite frames.

2. The independent multi-source display device of claim 1, wherein the multi-input receiver is configured to concurrently and separately communicate with each of the plurality of input sources without intervention of a central operating system or device external to the independent multi-source display device.

3. The independent multi-source display device of claim 1, wherein the plurality of input sources comprises a mobile electronic device in wireless communication with the independent multi-source display device.

4. The independent multi-source display device of claim 1, wherein the compositor is not integrated with, and packaged separately from, the plurality of formatters.

5. The independent multi-source display device of claim 1, wherein the multi-input receiver is configured to buffer the received plurality of input data in a ping-pong buffer.

6. The independent multi-source display device of claim 1, wherein the uncompressed data has an RGBA format comprising, red, green, and blue color information and alpha channel information.

7. The independent multi-source display device of claim 6, wherein the compositor is configured to composite the composite frames by blending overlapping uncompressed data using the alpha channel information associated with each of the overlapping uncompressed data.

8. The independent multi-source display device of claim 1, wherein the compositor is configured to composite the composite frames based on the depth order, the size, and the position of each of the uncompressed data received from the plurality of formatters, as determined based on the display element structure associated with each of the received uncompressed data.

9. An independent multi-source display device comprising:
a multi-input receiver configured to concurrently receive a plurality of input data from a plurality of input sources external to the independent multi-source display device, each of the plurality of input data having a display element structure indicating a data format, a depth order, a size, a position, and a content;
a compositor coupled to the receiver and comprising:
a plurality of formatters, each formatter of the plurality of formatters being configured to convert an input data having a data format associated with the formatter to uncompressed data,
the compositor being configured to identify a data format associated with each of the plurality of input data based on a respective display element structure of each of the plurality of input data, and to transmit each of the plurality of input data to one of the plurality of formatters associated with the identified data format,
the compositor being further configured to composite uncompressed data generated by the plurality of formatters into composite frames based on the display element structure associated with each of the received uncompressed data; and
a display panel configured to display the composite frames.

10. The independent multi-source display device of claim 9, wherein the multi-input receiver is configured to concurrently and separately communicate with each of the plurality of input sources without intervention of a central operating system or device external to the independent multi-source display device.

11. The independent multi-source display device of claim 9, wherein the plurality of input sources comprises a mobile electronic device in wireless communication with the independent multi-source display device.

12. The independent multi-source display device of claim 9, wherein the compositor is not integrated with, and packaged separately from, the plurality of formatters.

13. The independent multi-source display device of claim 9, wherein the multi-input receiver is configured to buffer the received plurality of input data in a ping-pong buffer.

14. The independent multi-source display device of claim 9, wherein the uncompressed data has an RGBA format comprising, red, green, and blue color information and alpha channel information.

15. The independent multi-source display device of claim 14, wherein the compositor is configured to composite the composite frames by blending overlapping uncompressed data using the alpha channel information associated with each of the overlapping uncompressed data.

16. The independent multi-source display device of claim 9, wherein the compositor is configured to composite the composite frames based on the depth order, the size, and the quadrilateral position of each of the uncompressed data received from the plurality of formatters, as determined based on the display element structure associated with each of the received uncompressed data.

17. A method for displaying content on an independent multi-source display device, the method comprising:
receiving, by a multi-input receiver, a plurality of input data from a plurality of input sources external to the independent multi-source display device, each of the plurality of input data having a display element structure indicating a data format, a depth order, a size, a position, and a content;
identifying a data format associated with each of the plurality of input data based on a respective display element structure of each of the plurality of input data;
transmitting each of the plurality of input data to one of a plurality of formatters associated with the identified data format;
converting, by the plurality of formatters, the plurality of input data to uncompressed data;
compositing, by a compositor, uncompressed data generated by the plurality of formatters into composite frames based on the display element structure associated with each of the received uncompressed data; and
displaying the composite frames on a display panel.

18. The method of claim 17, wherein the multi-input receiver is configured to concurrently and separately communicate with each of the plurality of input sources without intervention of a central operating system or device external to the independent multi-source display device.

19. The method of claim 17, wherein the uncompressed data has an RGBA format comprising, red, green, and blue color information and alpha channel information.

20. The method of claim 17, wherein the compositor is configured to composite the composite frames based on the depth order, the size, and the quadrilateral position of each of the uncompressed data received from the plurality of formatters, as determined based on the display element structure associated with each of the received uncompressed data.
